(19) United States
(12) Patent Application Publication
(10) Pub. No.: US 2008/0114728 A1
(43) Pub. Date: May 15, 2008

(54) METHODS AND APPARATUS FOR APPLYING SUCCESS METRICS AND METADATA COMMERCE IN SEARCH AND KNOWLEDGE SYSTEMS

(76) Inventor: Mark M. Huck, (US)

Correspondence Address: MARK M. HUCK, 912 2ND AVE. W., SEATTLE, WA, 98119, US

(21) Appl. No.: 11/558,906

(22) Filed: Nov. 11, 2006

(51) Int. Cl. G06F 17/30; G06F 7/00

(52) U.S. Cl. 707/3; 707/4; 707/E17.008; 707/E17.143

(57) ABSTRACT

For centuries written content has been subject to plagiarism, diminishing the value of the content to owners. This problem has been compounded by networked information spaces such as the Internet where content can be published widely in a very short period of time. The present invention solves one aspect of this problem by showing an information commerce system reliant on the value of content metadata as the goods rather than the actual words within the content. In this way, the content itself remains discoverable on the network while the underlying value is protected by the content owner.

### BACKGROUND OF THE INVENTION

1. Field of the Invention

This invention relates to Class 706 (DATA PROCESSING: ARTIFICIAL INTELLIGENCE), 45 (KNOWLEDGE PROCESSING SYSTEM), 59 (CREATION OR MODIFICATION), 60 (EXPERT SYSTEM OR SHELL).

2. Description

A primary method for users (or “consumers”) to find information on a network such as the Internet is through searches offered by various search sites. These search sites usually provide a text input field into which the user types a query. The site then returns search results containing links to pages or documents which are relevant to the query. This method of information retrieval has become very popular as the results become ever more relevant to the user. Google is currently a company that is prominent in this field. By using a mechanism called “page rank”, whereby the links to a site suggest its accuracy and validity, Google has made network search an extremely accurate way for user's to find information.

This search paradigm is particularly appropriate for atomic pieces of information, such as weather or news where the user may have enough contextual information to make informed decisions off limited information. As the size of the relevant context increases, however, the value of the individual fact decreases because the fact may be appropriate for only limited situations. Research is a type of information that generally requires extensive context in order to understand a limited fact. This context might include date, time, location, preconditions, history, risks, and so forth.

Each search result links to a page that contains content which the search engine has determined to be relevant to the user's query. This content has been earlier created or compiled by a content provider (“author” or “owner”). When the user visits the owner's page, the owner has limited options for obtaining payment for the value of the content. Generally, the advertising on the page provides the compensation to the owner.

Recently, web logs (or “blogs”) have also become a popular mechanism for providing content on the Internet. These blogs generally provide a mechanism (known as “feeds”) whereby users may subscribe to the blog, and view content via a client application called a “reader”. These feeds present the same problem to owners as web pages; namely, it is difficult for the owner to obtain payment for the content provided. In fact, because a subscriber could easily code a web page to display the feed content on the subscribers page or otherwise appropriate the content without payment, feeds amplify the problem of the owner.

To frustrate this unauthorized use, feeds generally will only contain a summary of the content, and not the full content. This “teaser” summary generally is meant to provide enough content so that the user will click through to the provider's blog. Again, however, from the user's standpoint, the user is forced to go to visit a single site rather than have an opportunity to aggregate information in one area for use.

For content owners desiring compensation for their effort in providing useful content, outside aggregation is currently not an option for receiving payment unless the user somehow subscribes to the aggregation service. More importantly, the owner's content may still be plagiarized without any compensation to the owner. This is a general problem for all creative work, but it perhaps most easily accomplished with written work because of the ease with which copying is possible with modern technologies. Thus, while content owners are battling to reduce the visibility of full content, consumers are seeking the fullest context possible. The goals would appear antithetical, but are not using the present invention.

A final problem exists within companies where additional information not generally available in a public space might provide context for content. Attributes such as employee success, team success, project success, and so forth provide valuable context to artifacts an employee might create. As the success of a project or employee within an organization increases, the likelihood that written content generated by the project or employee has greater organizational value also increases. Successful employees and projects are likely to produce artifacts which other employees and projects can emulate. Prior art does not show these success attributes applied systematically to refine search queries.

### Prior Art

U.S. Pat. No. 7,103,573 (to Peinado, et al.) and other similar patents describe digital rights management art designed to encode content to protect it from unauthorized reading. The present invention, however, is not concerned with the words comprising the content; rather, it is the metadata relationships within the content and between content items that are protected and, therefore, sellable.

No methods have been described, then, which provide at once a mechanism for content owners to receive compensation for their content while encouraging and increasing the availability of information to the consumer. These goals appear contradictory. However, by considering the metadata of the content to hold the majority of value for content, the content can be published absent the metadata and the user can compensate the owner—though advertising, subscriptions, or other mechanism—when accessing this content or its metadata.

Consider “Jimmy screamed and Julie covered her ears.” A simple combination of facts. The questions arise, are these two in the same location? Is it at the same time? How close are they? Did Julie do something to Jimmy? Is Julie covering her ears because of cold weather or noise? Metadata, then, provides the meaning to the statement. The content, however, is searchable. So, while the phase is discoverable, it's meaning is not. If the consumer has prior knowledge of Jimmy and Julie's situation, then metadata provided by the owner has little value. However, if the consumer does not have this contextual information, that information provides a wealth of information to the consumer. In fact, the statement is quite worthless without the context.

Or, consider “It is raining hard”. Well, is this a location where it rains seldom? Might there be flash floods? Is it Seattle, so you can expect that the rain will continue for 3 more months? Is the reporter reliable? Content in isolation get us just so far.

The present invention solves these problems while providing analytical capabilities not available in the current search paradigm or other prior art. The present invention is partially premised on the idea that it is the relationships and metadata that hold the primary value of content, particularly as the size and complexity of the content increases.

By selling the metadata and its associated content owners are unleashed to provide “full-text” feeds from their blogs. A virtuous loop ensues. The full-text is available to the consumer who then can pull this content into her information system and work on it. The content can reside on the Internet and be searchable there while the metadata that provides context and meaning remains private.

### SUMMARY OF THE INVENTION

The present invention contains two major contributions to networked knowledge management—corresponding to the claims later in this document—which are not disclosed by prior art.

First, the present invention discloses methods which publish content to a public location such as the Internet while keeping metadata unavailable to the public until a consumer subscribes to it. In doing so, the present invention allows for such content to be publicly searchable while keeping much of its inherent value, as encapsulated in its metadata, private. Thereby, the owner is able to structure ownership arrangements, such as subscriptions, with consumers and capture the value of this metadata.

The present invention further discloses the use of company organizational data to add further relevance to search results. The methods compute employee, team, group, and other relevance success criteria into the search result algorithm. As well, the

### Objects and Advantages

Accordingly, the objects and advantages of the present invention are:
(a) to provide a method and apparatus which publishes searchable content to a public network while providing a mechanism for the author or owner to obtain compensation of the content's underlying structure.
(b) to provide a method and apparatus which provides a means for authored content and its use on a network to be reported to human resources and other corporate information systems in order to provide a feedback loop for employee, project, and team success.
(c) to provide a method and apparatus which computes employee and project success in a content search algorithm.

Further objects and advantages are to enable the searching of content verbiage while maintaining strict ownership of logic and other metadata. Still further objects and advantages will become apparent from a consideration of the ensuing description and drawings.

### BRIEF DESCRIPTION OF THE DRAWINGS

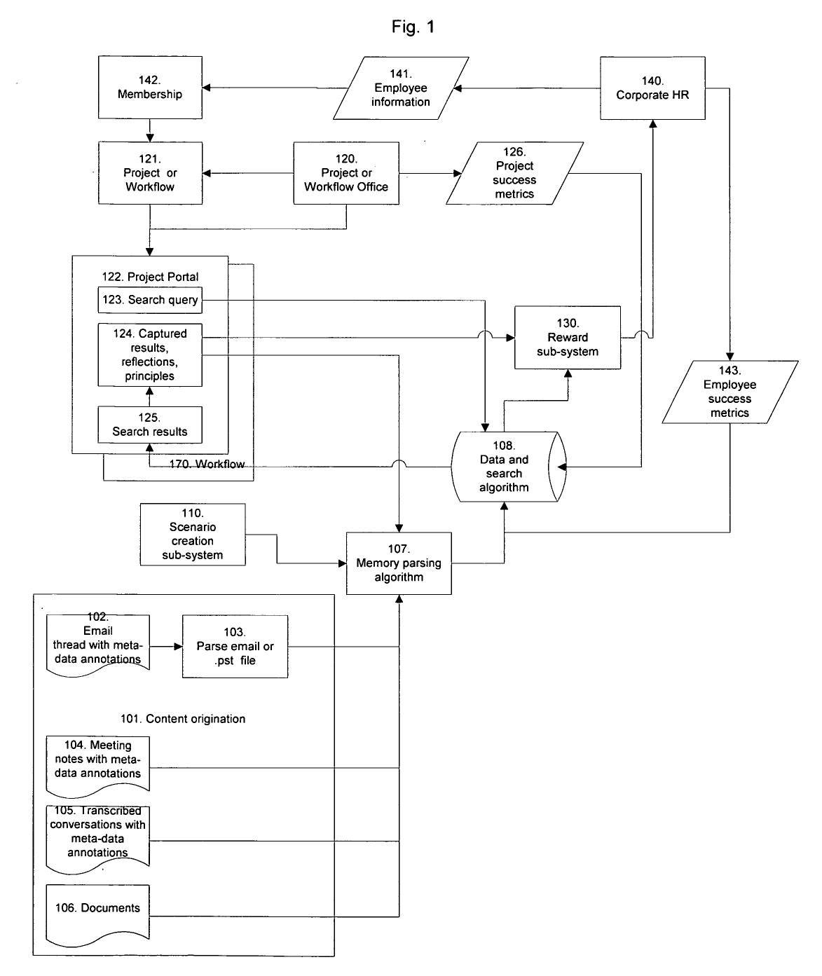

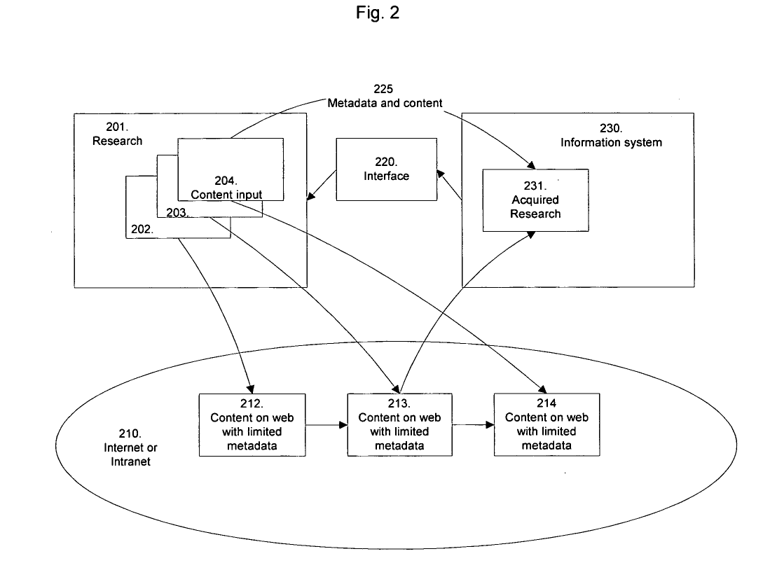

A typical embodiment of this invention is shown in drawing FIGS. 1 and 2. The figures should not be considered to limit the scope of the invention, and are shown to represent a typical embodiment of the invention claims.

### DETAILED DESCRIPTION OF THE PREFERRED EMBODIMENTS

A description of the present invention is shown in the flow-charts of FIGS. 1 and 2.

### Description of FIG. 1.

Original content (101) originate from email threads (102), meeting notes (104), conversions (105), documents (106), and other verbal sources within and outside of the corporation. Emails, for example, can be parsed (103). For all sources, meta-data annotations may be associated with parts of the text in order to provide more context for the source. For all sources, the project and author are captured as well when the memory is created.

A memory parsing algorithm (107) associates content with its component words and phrases. The same algorithm is applied to scenarios (110) and comments (124), which are also considered content sources, though derivative from the original source memories.

The data from the parsing is stored in a database (108).

A project (or workflow-creating) office (120) creates projects (121), reports project success (126) into the database (108), assigns members (142) to the projects (121), and sets up a project portal (122). This project portal (122) enables all searches (123), team comments (124), and results (125) to appear within the context of the project and its individuals.

A project member can initiate a search query (123) to the memories database (108) in order to find relevant memories to the search. The search algorithm (108) considers the words, phrases, links, and success metrics associated with memories, returning a ranked result-set (125) to the portal (122).

Team members can capture and annotate (124) memories, creating a new memory going into the memory algorithm (107). This algorithm will be explained in greater detail below.

Alternately, the searches would take place in the context of a workflow (170). As a member of the workflow reached a new workflow stage, or picked up a new workflow stage assigned to her, memories could be queried within this context. In this case, the project portal (122) would be a portal for members of the workflow.

Corporate human resources (140) supplies member information (141) to the project office (120), as well as reports employee success metrics (143), such as promotions, to the memory database (108). Both the project success metrics (126) and the employee success metrics (143) are used in the search algorithm.

A reward sub-system (130) captures usage information associated with memories created by individuals and teams. The individuals and teams are thereby rewarded for creating and usage of their memories.

A scenario creation subsystem (110) submits scenario queries to the memories database (108). The results are analyzed for ability to create result-sets (similar to (125)) with high success metrics. As these memories are created and stored, the source memories are faded by using a fading factor in the algorithm.

### Description of FIG. 2.

Operator who owns content (“owner”) inputs content 202, 203, and 204 into research 201 and includes metadata such as categorization, start time, end time, geographical boundaries, limits, risks, etc. The content with only a subset of the metadata is published to the public network as content 212, 213, and 214. When an operator who will consume the content (“consumer”) views public content in search results and then selects for inclusion in consumer's information system 230, the research is added as item 231 by transfer via interface 220 from the owner's research 201 to the consumer's information system 230.

### CONCLUSIONS, RAMIFICATIONS, AND SCOPE

Accordingly, the reader will see that this invention provides highly functional methods for compensating content owners on the an internet or intranet. Although the description above contains many specificities, these should not be construed as limiting the scope of the invention but as merely providing illustrations of some of the presently preferred embodiments of this invention. Thus, the scope of the invention should be determine by the appended claims and their legal equivalents, rather than by the examples given.

### REFERENCES

Chi, Ed H., and Peter Pirolli, “Social Information Foraging and Collaborative Search, http://www.parc.xerox.com/research/publications/files/5677.pdf
Ding, Li, et al. “Finding and Ranking Knowledge on the Semantic Web”, Proceedings of the 4^{th} International Semantic Web Conference”, Galway IE, November 2005 http://ebiquity.umbc.edu/_file_directory_/papers/197.pdf and http://ebiquity.umbc.edu/paper/html/id/241/Finding-and-Ranking-Knowledge-on-the-Semantic-Web
Earley, Seth, “Taxonomies, Metadata, and Search” hytp://www.enterprisesearchcenter.com/Newsletters/ESNewsletter.aspx?NewsletterID=419 #1
Huynh, David Francois, “A User Interface Framework for Supporting Information Management Tasks in Haystack,” Masters Thesis for M.I.T., May, 2003, http://haystack.Ics.mit.edu/publications.html
Joyce, Erin, “Online Publishers Debate Free vs. Paid Content,” Mar. 19, 2002, http://www.atnewyork.com.news/article.php/8471_{—}994361
Millen, David, Jonathan Feinberg, and Bernard Kerr, IBM, “Social Bookmarking in the Enterprise”, in Social Computing, Vol. 3, No. 9, November 2005, http://acmqueue.com/modules.php?name=Content&pa=Printer_friendly&pid=344&page=1
Mort, David, “Free versus Fee-based Information Services” May, 2000, http://scientific.thomson.com/free/ipmatters/infosearch/8203172/
Quan, Dennis A, Jr. “Designing End User Information Environments Built on Semistructured Data Models”, Doctoral Thesis for M.I.T., June 2003, http://portal.acm.org/citation.cfm?id=979477&dl=ACM&coll=&CFID=15151515&CFTOKEN=6184618
Seomoz.org, “Search Engine Ranking Factors,” http://www.seomoz.org/articles/search-ranking-factors.php
Slawski, William, “20 Ways Search Engines May Rerank Search Results”, Oct. 14, 2006, http://www.seobythesea.com/?p=334
Weibel, Stuart, “An Introduction to Dublin Core”, http://www.xml.com/pub/a/2000/10/25/dublincore/index.html

I claim:

1. A method for offering to an operator an owner's content and its metadata in a computer network comprising
a. providing a memory which is able to store incoming information received over a network into said memory,
b. providing a processor,
c. providing such network devices necessary to connect to a network of computers,
d. providing a display which is operatively connected to such memory,
e. providing a browser program able to transfer and receive information and place such information into memory in a way available to the processor, and showing information on said display,
f. providing a character input means which a human operator can use to enter information into said browser
whereby operator who is content owner (“owner”) can enter into an information system one or more content items each having one or more attributes whose values are specified by owner whereby one or more of the content items each without one or more of the attributes are published onto a network such that such content may be discovered by search engine crawlers and other network users.

2. The method of claim 1 wherein a content consumer (“consumer”) may view the owner's content and select it to include in consumer's information system which accepts the same attributes as the owner's information system.

3. The method of claim 2 said method will add the content and metadata to the consumer's information system so that the metadata is available to the operator's information system whereby an operator can view operator's information system and see the offered content.

4. The method of claim 3 wherein the owner is credited with the financial or non-financial sale of the content.

5. The method of claim 3 wherein the content and metadata is refreshed in the consumer's information system when the owner changes the content or metadata within the owner's system

6. The method of claim 4 wherein the owner is credited for each subsequent revision or use of the content by the consumer.

7. The method of claim 2 wherein the input mechanism is email generated by the operator and sent to the system.

8. A method for providing search results to an operator in a computer network comprising
a. providing a memory which is able to store incoming information received over a network into said memory,
b. providing a processor,
c. providing such network devices necessary to connect to a network of computers,
d. providing a display which is operatively connected to such memory,
e. providing a browser program able to transfer and receive information and place such information into memory in a way available to the processor, and showing information on said display,
f. providing a character input means which a human operator can use to enter information into said browser
whereby personal, team, group, department and other human resources information is calculated into the search relevance algorithm in order to derive content relevance.

9. The method of claim 8 wherein search results that are selected for use are also reported back to the company's human resources department.

10. The method of claim 8 wherein ratings made within the organization on content input by such person are added into a reward subsystem accessible to other members of the organization.

11. The method of claim 8 wherein searches made on content input by such person are added into a reward subsystem accessible to other members of the organization.

12. A method for providing search results to an operator in a computer network comprising
a. providing a memory which is able to store incoming information received over a network into said memory,
b. providing a processor,
c. providing such network devices necessary to connect to a network of computers,
d. providing a display which is operatively connected to such memory,
e. providing a browser program able to transfer and receive information and place such information into memory in a way available to the processor, and showing information on said display,
f. providing a character input means which a human operator can use to enter information into said browser
whereby project or other organizational information is calculated into the search relevance algorithm in order to derive content relevance.

13. The method of claim 12 wherein search results that are selected for use are also reported back to the company's human resources department.

14. The method of claim 12 wherein ratings made within the organization on content input by such person are added into a reward subsystem accessible to other members of the organization.

15. The method of claim 12 wherein searches made on content input by such person are added into a reward subsystem accessible to other members of the organization.
